(19) United States
(12) Patent Application Publication
(10) Pub. No.: US 2004/0259748 A1
(43) Pub. Date: Dec. 23, 2004

(54) Dishwashing composition

(76) Inventors: Ralf Wiedemann, Ludwigshafen (DE); Marcus Guzmann, Muehlhausen (DE)

Correspondence Address: Norris McLaughlin & Marcus, 30th Floor, 220 East 42nd Street, New York, NY, 10017, US

(21) Appl. No.: 10/483,368

(22) PCT Filed: Jul. 9, 2002
(86) PCT No.: PCT/GB02/03134

(30) Foreign Application Priority Data
Jul. 11, 2001 (GB) 0116882.2

(51) Int. Cl. C11D 1/00

(52) U.S. Cl. 510/220

(57) ABSTRACT

Cleaning product for use in automatic dishwashing comprising at least one surfactant having a cloud point in the range from 20° C. to 70° C., wherein at least said surfactant is enclosed in an enclosure made at least partially of a water-soluble material, the enclosure being adapted to be capable of delaying the release of its contents until when or after the temperature in the dishwashing appliance has reached the cloud point of said surfactant.

The present invention is related to a cleaning product for use in automatic dishwashing, a process for automatic dishwashing as well as a method of washing soiled tableware in an automatic dishwashing appliance using such cleaning product.

Automatic dishwashing, particularly in domestic appliances, is an art very different from fabric laundering. Domestic fabric laundering is normally done in purpose-built machines having a tumbling action. These are very different from spray-action domestic automatic dishwashing appliances. The spray action in the latter tends to cause foam. Foam can easily overflow the low sills of domestic dishwashers and slow down the spray action, which in turn reduces the cleaning action. Thus, in the distinct field of domestic machine dishwashing, the use of common foam-producing laundry detergent surfactants is normally restricted. These aspects are but a brief illustration of the unique formulation constraints in the domestic dishwashing field. On account of the foregoing technical constraints as well as consumer needs and demands, automatic dishwashing detergent (ADD) compositions are undergoing continual changes and improvements. Moreover, environmental factors, such as the restriction of phosphate, the desirability of providing ever-better cleaning results with less product, providing less thermal energy, and less water to assist the washing process, have all driven the need for improved ADD compositions.

In spite of such continuing changes to the formulation of ADD compositions, there continues to be a need for better dishwashing processes and better ADD compositions, especially for what regards spotting and filming results.

One way of improving the spotting and filming behaviour could be to increase the amount of surfactants present in the formulations and to simultaneously change and improve the surfactants used. However, as noted hereinbefore, ADD compositions have the unique limitation of requiring very low sudsing compositions which is incompatible with most of the surfactant systems and ingredients typically used in other cleaning compositions. Even low foaming surfactants can generate excessive foaming when their concentration in the washing liquor exceeds certain levels.

Traditionally low cloud point, low foaming non-ionic surfactants have been used in ADD formulations at low levels in order to avoid the above-mentioned foaming problem. But the performance therefrom has generally been very limited due to the requirement that low amounts of low foaming non-ionic surfactants are used.

An approach to improve the rinse performance of dishwashing detergent has been to enclose a non-ionic surfactant within ADD formulations with means to guarantee that the surfactant survives the washing cycle and is predominantly released in the rinse cycle.

One example of this route can be found in German Patent Application DE 198 34 180.6 where the surfactant is present in the form of a shaped body coated with a specific material which is pH sensitive and only dissolves upon pH drop at the beginning of the rinse cycle. Such coating is, however, stable during the cleaning cycle, i.e. under alkaline conditions. This assures that the low cloud point surfactant is only delivered at the rinse cycle.

Another example of this route can be found in PCT Application No. 95/29982 where it is proposed to add coated surfactant-containing particles to a dishwashing detergent. According to this invention the particles are coated with a material selected so that it does not melt at the temperatures encountered during the washing cycle, but gradually chemically disintegrates at the alkaline pHs of the wash cycle so that an effective amount of the wash additive survives the wash cycle and is delivered into the rinse cycle.

This approach is onerous because it requires the step of coating the surfactant-containing materials to be added to the dishwashing composition which complicates the manufacturing process and has a high impact on the cost of the detergent composition. Furthermore, the materials proposed in the above-mentioned application are non-beneficial in the dishwashing process as they are selected from a class of waxy materials which are known to decrease spotting and filming results. In addition it is noteworthy that the method described would only apply to solids or liquids supported by solid absorbents.

A different approach has been to incorporate a high content of surfactant into the ADD formulation in order to achieve carry-over of a substantial proportion of the surfactant into the rinse cycle to perform there. This route has been proposed in two patent applications (WO98/32823 A1 and DE 200 14 919 U1) which are based on the use of high amounts of surfactants which are carried over to the rinse cycle where they contribute to the rinsing performance. Both disclosures teach that it is recommendable to use low foaming surfactants (and thus low cloud point surfactants) to prevent foaming problems (see WO 98/32823, page 11, lines 24-26 and DE 200 14 919 U1, page 4, 3^{rd} paragraph).

The problem to achieve rinse performance through the incorporation of high levels of unprotected surfactants into ADD formulations is essentially that surfactants with good sheeting properties, such as ethoxylated non-ionics, do foam substantially when incorporated into an ADD formulation, i.e. when being dissolved during the cleaning cycle. Moreover, increasing the surfactant content (for these or other surfactants) to ensure the desired carry-over of surfactant into the rinse cycle, do also pose significant problems because of excessive foaming during the cleaning cycle which is undesirable. As possible solutions it has been proposed to add specific defoamers or to use a mixture with specific low foaming surfactants which is, however, expensive and possibly affects the surfactant performance.

Among the substances which having been proposed to control foaming of moderate to high-foaming surfactants in automatic dishwashers one can cite alkyl phosphate ester suds suppressor, silicone suds suppressor, or combinations thereof at levels from 0% to 10%, preferably, from 0.001% to 5% of the total detergent composition.

However, suds suppressing agents are undesirable from one side because they are costly raw materials which has an impact on the overall cost of the detergent compositions generally and from another side because they can deposit onto the surfaces of the ware being washed impairing the filming and spotting results obtained.

It is an object of the present invention to provide for a method of cleaning dishware in automatic dishwashers permitting the use of moderate to high amounts of moderate to high cloud point non-ionic surfactants.

It is a further object of the present invention to provide for an improved cleaning product for use in automatic dishwashing which would allow incorporation of a high content of moderate to high cloud point surfactant to ensure sufficient carry-over of surfactant into the rinse cycle, simultaneously avoiding undesirable high foaming during the cleaning cycle.

For solution of these objects, the present invention provides for a cleaning product for use in automatic dishwashing comprising at least one surfactant having a cloud point in the range from 20° C. to 70° C., preferably below 65° C., most preferably below 55° C., and still most preferably below 45° C., wherein at least said surfactant is enclosed in an enclosure made at least partially of a water-soluble material, the enclosure being adapted to be capable of delaying the release of its contents until when or after the temperature in the dishwash[er]ing appliance has reached the cloud point of said surfactant [a value at least equal to the surfactant's cloud point]

The solution proposed in the present invention is particularly effective when amount of moderate to high cloud point surfactants are used. Thus, it is a preferred embodiment of the invention to have cleaning product with a surfactant content, based on a or the complete, fully functional formulation for automatic dishwashing, between 2 and 60 wt. %, more preferably between 4 and 50 wt. %, most preferably between 5 and 40 wt. %.

In a preferred embodiment of the invention, the enclosure is a foil or a container.

Preferably, the water-soluble material of the enclosure comprises a polymeric material. Water-soluble polymer materials are known in the art and comprise for instance members of the group consisting of polyvinyl alcohol (optionally partially acetalised and/or alkoxylated), polyvinyl pyrrolidone, water-soluble polyacrylates, water-soluble polyurethane, polyethyleneoxide, gelatine, cellulose derivatives and mixtures thereof. The preferred enclosure comprises polyvinyl alcohol, preferably is essentially made of polyvinyl alcohol. (The term polyvinyl alcohol as used herein and hereafter is meant to encompass partly or fully hydrolysed polyvinylacetates having a degree of hydrolysis of at least 50%, more preferably from 85 to 100%).

The solubility of PVA depends on its degree of polymerisation and on its degree of hydrolysis and additionally it can be modified to a desired value by after-treatment with aldehydes (acetalisation), by complexation with metal ions (e.g. Ni or Cu salts) or by treatment with dichromates, or crosslinking agents (e.g. boric acid, borax or titanium dioxide). All these means can be used to match the temperature of solubilisation of the film with the cloud point value of the surfactant to achieve the benefits of the invention. In addition the thickness of the film can also be used to fine-tune the dissolution of the film.

Preferably, the composition comprises further ingredients of an automatic dishwashing formulation, being most preferably a complete, fully functional formulation for automatic dishwashing. It is possible to enclose part or all of the composition provided that at least the moderate-to-high cloud point surfactant is enclosed.

Moreover, the invention is directed to a process for automatic dishwashing using a cleaning product comprising at least one surfactant having a cloud point in the range from 20° C. to 70° C., preferably below 65° C., most preferably below 55° C. and still most preferably below 45° C., wherein at least said surfactant is released into the wash liquor during the cleaning cycle of the automatic dishwashing process only when or after the temperature of the wash liquor has reached the cloud point of said surfactant. The composition and/or thickness of the water-soluble enclosure is adapted to ensure that release of the material enclosed therewith will not occur before reaching a temperature of equal or higher than the cloud point of the selected surfactants.]

Finally, the invention is directed to a method of washing soiled tableware in an automatic dishwashing appliance comprising treating said soiled tableware with an aqueous alkaline bath comprising a cleaning product according to the invention.

The present invention provides for a surprisingly simple solution of the underlying objects. The essence of the technical teaching of the present invention is to allow the use of otherwise excessively foaming surfactants by providing for means to guarantee that the surfactant is released in the washing cycle only when or after the temperature of the washing liquor has reached the surfactant's cloud point. This solution is additionally less expensive and less difficult to apply than the coatings of the prior art which function by delaying the release of the surfactant until the rinse cycle.

Thus according to the present invention the surfactant(s), and preferably the complete AD[W]D formulation, is released during the washing cycle, however, with some delay. This delay ensures that the surfactant will only be released at a point in time when the temperature of the wash liquor is already substantially increased, namely at or above the cloud point of the surfactant. At temperatures above the cloud point, surfactants do show significantly lower foaming than below so that by those means it can be ensured that foaming will be minimized, even with high content of high performing surfactants being present already in the cleaning cycle.

The full advantages of the invention will only be achieved when using surfactants having a cloud point higher than ambient temperature, as surfactants with a cloud point at or below ambient temperature would already show low foaming when released into the wash liquor at the beginning of the cleaning cycle, i.e. when the water has not been heated. Thus, a surfactant is to be used having a cloud point of above ambient temperature, namely greater than 20° C. However, the highest cloud point-acceptable is equal or below the highest temperature reached throughout the main cycle. Therefore a cloud point greater than 20° C., but below 70° C., preferably below 65° C., most preferably below 55° C., still most preferably below 45° C. is desirable.

Any means which can delay the release of the foaming surfactant into the washing liquor until temperature of the liquor is at least equal to the value of the surfactant's cloud point can be used to achieve the benefits of the present invention.

One such means is to envelop the surfactant or a composition comprising the surfactant in a water-soluble enclosure whose solubility is selected so that it will release the surfactant only at the desired temperature.

The ADD compositions of the invention preferably comprise a bleaching system which is a source of hydrogen peroxide, preferably perborate and/or percarbonate, and preferably also comprise a bleach catalyst or a bleach activator.

The preferred detergent compositions herein further comprise a protease and/or amylase enzyme. Whereas conventional amylases such as TERMAMYL® may be used with excellent results, preferred ADD compositions can use oxidative stability-enhanced amylases. Such an amylase is available from Novo Nordisk. and from Genencor International. Oxidative stability is enhanced by substitution of the methionine residue located in position 197 of B.Licheniformis or the homologous position variation of a similar parent amylase. Typical proteases include Esperase, Savinase, and other proteases as described hereinafter.

The present invention encompasses (but is not limited to) liquid-form, fully-formulated ADD compositions in which additional ingredients, including other enzymes (especially proteases and/or amylases) are formulated, along with other ADD product forms such as gels, powders and tablets.

All parts, percentages and ratios used herein are based on weight unless otherwise specified. All documents cited are, in relevant part, incorporated herein by reference.

### DETAILED DESCRIPTION OF THE INVENTION

### Automatic Dishwashing Compositions

Automatic dishwashing compositions of the present invention comprise a surfactant system, and preferably also include one or more builders, a bleaching agent (such as a chlorine bleach or a source of hydrogen peroxide) and/or detersive enzymes. Bleaching agents useful herein include chlorine bleaches (e.g., hypochlorite or NaDCC) and sources of hydrogen peroxide, including any common hydrogen-peroxide releasing salt, such as sodium perborate, sodium percarbonate, and mixtures thereof. Also useful are sources of available oxygen such as persulfate bleach. In the preferred embodiments, additional ingredients such as water-soluble silicates (useful to provide alkalinity and assist in controlling corrosion), dispersant polymers (which modify and inhibit crystal growth of calcium and/or magnesium salts), chelants (which control transition metals), alkalis (to adjust pH), and detersive enzymes (to assist with tough food cleaning, especially of starchy and proteinaceous soils), are present. Additional bleach-modifying materials such as conventional bleach activators (e.g. TAED and/or bleach catalysts) may be added, provided that any such bleach-modifying materials are delivered in such a manner as to be compatible with the purposes of the present invention. The present detergent compositions may, moreover, comprise one or more processing aids, fillers, perfumes, conventional enzyme particle-making materials including enzyme cores or “nonpareils”, as well as pigments, and the like.

In general, materials used for the production of ADD compositions herein are preferably checked for compatibility with spotting/filming on glassware. Test methods for spotting/filming are generally described in the automatic dishwashing detergent literature, including DIN and ASTM test methods. Certain oily materials and insoluble materials such as clays, as well as long-chain fatty acids or soaps which form soap scum are therefore preferably limited or excluded from the instant compositions.

Amounts of the essential ingredients can vary within wide ranges, however preferred automatic dishwashing detergent compositions herein (which typically have a 1% aqueous solution pH of above 8, more preferably from 9.5 to 12, most preferably from 9.5 to 10.5) are those wherein there is present: from 5% to 90%, preferably from 5% to 75%, of builder; from 0.1% to 40%, preferably from 0.5% to 30%, of bleaching agent; from 0.1% to 15%, preferably from 0.2% to 10%, of the surfactant system; from 0.0001% to 1%, preferably from 0.001% to 0.05%, of a metal-containing bleach catalyst; and from 0.1% to 40%, preferably from 0.1% to 20% of a water-soluble silicate. Such fully-formulated embodiments typically further comprise from 0.1% to 15% of a polymeric dispersant, from 0.01% to 10% of a chelant, and from 0.00001% to 10% of a detersive enzyme, though further additional or adjunct ingredients may be present. Detergent compositions herein in granular form typically limit water content, for example to less than 7% free water, for best storage stability.

While the present invention compositions may be formulated using chlorine-containing bleach additive, preferred ADD compositions of this invention (especially those comprising detersive enzymes) are substantially free of chlorine bleach. By “substantially free” of chlorine bleach is meant that the formulator does not deliberately add a chlorine-containing bleach additive, such as a dichloroisocyanurate, to the preferred ADD composition. However, it is recognised that because of factors outside the control of the formulator, such as chlorination of the water supply, some non-zero amount of chlorine bleach may be present in the wash liquor. The term “substantially free” can be similarly constructed with reference to preferred limitation of other ingredients.

By “effective amount” herein is meant an amount which is sufficient, under whatever comparative test conditions are employed, to enhance cleaning of a soiled surface. Likewise, the term “catalytically effective amount” refers to an amount of metal-containing bleach catalyst which is sufficient under whatever comparative test conditions are employed, to enhance cleaning of the soiled surface. In automatic dishwashing, the soiled surface may be, for example, a porcelain cup with tea stain, a porcelain cup with lipstick stain, dishes soiled with simple starches or more complex food soils, or a plastic spatula stained with tomato soup. The test conditions will vary, depending on the type of washing appliance used and the habits of the user. Some machines have considerably longer wash cycles than others. Some users elect to use warm water without a great deal of heating inside the appliance; others use warm or even cold water fill, followed by a warm-up through a built-in electrical coil. Of course, the performance of bleaches and enzymes will be affected by such considerations, and the levels used in fully-formulated detergent and cleaning compositions can be appropriately adjusted.

### Moderate to High Cloud Point Non-Ionic Surfactant

Non-ionic surfactants useful in ADD compositions of the present invention are desirably included in the present detergent compositions at levels of from 2% to 60% of the composition. In general, bleach-stable surfactants are preferred. Non-ionic surfactants generally are well known, being described in more detail in Kirk Othmer's Encyclopedia of Chemical Technology, 3rd Ed., Vol. 22, pp. 360-379, “Surfactants and Detersive Systems”, incorporated by reference herein.

While a wide range of non-ionic surfactants may be selected from for purposes of the surfactant systems useful in the present invention ADD compositions, it is necessary that the surfactant system comprise at least one moderate to high cloud point non-ionic surfactant as described as follows. “Cloud point”, as used herein, is a well known property of non-ionic surfactants which is the result of the surfactant becoming less soluble with increasing temperature, the temperature at which the appearance of a second phase is observable is referred to as the “cloud point” (See Kirk Othmer, pp. 360-362, hereinbefore).

As used herein, a “moderate-to-high cloud point” non-ionic surfactant is defined as a non-ionic surfactant having a cloud point greater than 20° C., but below 70° C., preferably below 65° C., most preferably below 55° C., still most preferably below 45° C. On the other hand, the cloud point is preferably greater than 25° C., most preferably greater than 30° C., so that the preferred range for the moderate-to-high cloud point non-ionic surfactant of the invention is between 30° C. and 45° C.

A variety of non-ionic surfactants can be used according to the invention provided they posses a cloud point between 20 and 70° C. These nonionic surfactants will be referred to as “moderate-to-high cloud point nonionic surfactants” in this specification.

One possible class of moderate-to-high cloud point nonionics are ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol.

Particularly preferred non-ionic surfactants are the non-ionic from a linear chain fatty alcohol with 16-20 carbon atoms and at least 12 moles particularly preferred at least 16 and still more preferred at least 20 moles of ethylene oxide per mole of alcohol.

According to one preferred embodiment of the invention, the non-ionic surfactants additionally comprise propylene oxide units in the molecule. Preferably this PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of moderate-to-high cloud point non-ionic surfactants includes reverse block copolymers of polyoxyethylene and polyoxypropylene and block copolymers of polyoxyethylene and polyoxypropylene initiated with trimethylolpropane.

Another preferred moderate-to-high cloud point nonionic surfactant can be described by the formula:

R¹O[CH₂CH(CH₃)O]_{X}[CH₂CH₂O]_{Y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred moderate-to-high cloud point nonionic surfactants are the end-capped polyoxyalkylated non-ionics of formula:

R¹O[CH₂CH(R³)O]ₓ[CH₂]ₖCH(OH) [CH₂]ⱼOR²

w[W]here R¹ and R² represent linear or branched chain, saturated or unsaturated, alyphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is ≧2 each R³ in the formula above can be different. R¹ and R² are preferably linear or branched chain, saturated or unsaturated, alyphatic or aromatic hydrocarbon groups with 6-22 carbon atoms, where group with 8 to 18 carbon atoms are particularly preferred. For the group R³H, methyl or ethyl are particularly preferred. Particularly preferred values for x are comprised between 1 and 20, preferably between 6 and 15.

As described above, in case x≧2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]ₓCH₂CH(OH)CH₂OR²

The use of mixtures of different nonionic surfactants is particularly preferred in the context of the present invention for instances mixtures of alkoxylated alcohols and hydroxy group containing alkoxylated alcohols.

Method to Measure the Foam Profile of Surfactants in an Automatic Dishwasher

A method for the evaluation of the suds suppression power of automatic dishwashing detergent compositions and/or additives containing foaming ingredients by Measuring Dishwasher Arm RPM Efficiency is describe hereunder.

Equipment: A Bosch Dishwasher (model Boschaqua SGS 6902) equipped with a Pt 100, a sensor (inductive) (Turck Corp, model: BI10U/Q14/AP6X2), revolution counter (Turck Corp., model: MS25/UI/230VAC), bus manager/32 (Delphin Systeme Corp.), Data-logger Lab-Message 8F (Delphin Systeme Corp.), connected to a personal computer. Data are collected with Delphin Mhouse-Software (Delphin Systeme Corp.).

Data are collected as follows. The proximity sensor is affixed to the bottom dishwasher rack on a metal bracket. The sensor faces upwards toward the rotating dishwasher arm of the machine (distance approximately 1-1,5 cm from the rotating arm). Each pass of the rotating arm is measured by the sensor and recorded. The pulses recorded by the computer are converted to rotations per minute (RPM) of the bottom arm by counting pulses over a 60 second interval. The rate of the arm rotation is directly proportional to the amount of suds in the machine and in the dishwasher pump (i.e., the more suds produced, the slower the arm rotation).

Procedure: The following procedure may be used to evaluate the foaming behaviour of automatic dishwashing detergent compositions and/or additives as well as surfactant/antifoam systems for the use in domestic household dishwashing machines.

The machine is started in the 55° C. (2° dH) normal program and the RPM is monitored throughout the whole cycle substantially comprised of a pre-rinse (no detergent present) a main wash (in which the detergent is dosed) and the final rinse. In the main wash at the point in time the dosage chamber opens the automatic dishwashing detergent composition (optionally containing further ingredients) and 3 g of (mixed) full egg is added to the wash liquor (compositions are added by opening the machine front door and placing a beaker containing the composition/egg upside down in the top rack).

The RPM in the prewash and in the absence of composition is used as the control and the RPM value recorded is taken as the ideal RPM (R1). In the wash cycle and after the addition of automatic dishwashing detergent compositions and/or additives (optionally containing further ingredients) and 3 g of (mixed) full egg the RPM are monitored. The value obtained as an average for the first 10 min is used as the RPM value for the composition (R2). The suds suppression is calculated following the formula:

R2×100/R1=x (x=efficacy of suds suppression in %)

Optionally the method can also be used for testing of compositions for use in the rinse cycle. In this case the first 10 min after addition of the composition for use in the rinse aid are used to record and calculate R2.

For a surfactant/composition to be considered adequate it must produce a value for x preferably greater than 50%, more preferably greater than 65%, most preferably greater than 80%.

### Builders

Detergent builders other than silicates can optionally be included in the compositions herein to assist in controlling mineral hardness. Inorganic as well as organic builders can be used. Builders are used in automatic dishwashing to assist in the removal of particulate soils.

The level of builder can vary widely depending upon the end use of the composition and its desired physical form. The compositions will typically comprise at least 1% builder. High performance compositions typically comprise from 5% to 90%, more typically from 5% to 75% by weight, of the detergent builder. Lower or higher levels of builder, however, are not excluded.

Inorganic or non-phosphate-containing detergent builders include, but are not limited to, phosphonates, phytic acid, silicates, carbonates (including bicarbonates and sesquicarbonates), sulfates, citrate, zeolite or layered silicate, and aluminosilicates.

Organic detergent builders suitable for the purposes of the present invention include, but are not restricted to, a wide variety of polycarboxylate compounds. As used herein, “polycarboxylate” refers to compounds having a plurality of carboxylate groups, preferably at least 3 carboxylates. Polycarboxylate builder can generally be added to the composition in acid form, but can also be added in the form of a neutralized salt or “overbased”. When utilised in salt form, alkali metals, such as sodium, potassium, and lithium, or alkanolammonium salts are preferred.

Included among the polycarboxylate builders are a variety of categories of useful materials. One important category of polycarboxylate builders encompasses the ether polycarboxylates, including oxydisuccinate.

Other useful detergency builders include the ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediaminetetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Citrate builders, e.g., citric acid and soluble salts thereof (particularly sodium salt), are polycarboxylate builders of particular importance for heavy duty laundry detergent and automatic dishwashing formulations due to their availability from renewable resources and their biodegradability. Citrates can also be used in combination with zeolite, the aforementioned BRITESIL types, and/or layered silicate builders. Oxydisuccinates are also useful in such compositions and combinations.

Where phosphorus-based builders can be used, the various alkali metal phosphates such as the well-known sodium tripolyphosphates, sodium pyrophosphate and sodium orthophosphate can be used. Phosphonate builders such as ethane-1-hydroxy-1,1-diphosphonate and other known phosphonates can also be used though such materials are more commonly used in a low-level mode as chelants or stabilizers.

Phosphate detergent builders for use in ADD compositions are well known. They include, but are not limited to, the alkali metal, ammonium and alkanolammonium salts of polyphosphates (exemplified by the tripolyphosphates, pyrophosphates, and glassy polymeric meta-phosphates).

Preferred levels of phosphate builders herein are from 10% to 75%, preferably from 15% to 50%, of phosphate builder.

### Bleaching Agents

Hydrogen peroxide sources are described in detail in the herein incorporated Kirk Othmer's Encyclopedia of Chemical Technology, 4th Ed (1992, John Wiley & Sons), Vol. 4, pp. 271-300 “Bleaching Agents (Survey)”, and include the various forms of sodium perborate and sodium percarbonate, including various coated and modified forms. An “effective amount” of a source of hydrogen peroxide is any amount capable of measurably improving stain removal (especially of tea stains) from soiled dishware compared to a hydrogen peroxide source-free composition when the soiled dishware is washed by the consumer in a domestic automatic dishwasher in the presence of alkali.

More generally a source of hydrogen peroxide herein is any convenient compound or mixture which under consumer use conditions provides an effective amount of hydrogen peroxide. Levels may vary widely and are usually in the range from 0.1% to 70%, more typically from 0.5% to 30%, by weight of the ADD compositions herein.

The preferred source of hydrogen peroxide used herein can be any convenient source, including hydrogen peroxide itself. For example, perborate, e.g., sodium perborate (any hydrate but preferably the mono- or tetra-hydrate), sodium carbonate peroxyhydrate or equivalent percarbonate salts, sodium pyrophosphate peroxyhydrate, urea peroxyhydrate, or sodium peroxide can be used herein. Also useful are sources of available oxygen such as persulfate bleach. Sodium perborate monohydrate and sodium percarbonate are particularly preferred. Mixtures of any convenient hydrogen peroxide sources can also be used.

While not preferred for ADD compositions of the present invention which comprise detersive enzymes, the present invention compositions may also comprise as the bleaching agent a chlorine-type bleaching material. Such agents are well known in the art, and include for example sodium dichloroisocyanurate (“NaDCC”).

While effective ADD compositions herein may comprise only the non-ionic surfactant system and builder, fully-formulated ADD compositions typically will also comprise other automatic dishwashing detergent adjunct materials to improve or modify performance. These materials are selected as appropriate for the properties required of an automatic dishwashing composition.

### Adjunct Materials

Detersive ingredients or adjuncts optionally included in the instant compositions can include one or more materials for assisting or enhancing cleaning performance, treatment of the substrate to be cleaned, or designed to improve the aesthetics of the compositions. They are further selected based on the form of the composition, i.e., whether the composition is to be sold as a liquid, paste (semi-solid), or solid form (including tablets and the preferred granular forms for the present compositions). Adjuncts which can also be included in compositions of the present invention, at their conventional art-established levels for use (generally, adjunct materials comprise, in total, from 30% to 99.9%, preferably from 70% to 95%, by weight of the compositions), include other active ingredients such as non-phosphate builders, chelants, enzymes, suds suppressors, dispersant polymers (e.g., from BASF Corp. or Rohm & Haas), colour speckles, silvercare, anti-tarnish and/or anti-corrosion agents, dyes, fillers, germicides, alkalinity sources, hydrotropes, anti-oxidants, enzyme stabilizing agents, perfumes, solubilizing agents, carriers, processing aids, pigments, pH control agents, and, for liquid formulations, solvents, as described in detail hereinafter.

### Detersive Enzymes

“Detersive enzyme”, as used herein, means any enzyme having a cleaning, stain removing or otherwise beneficial effect in an ADD composition. Preferred detersive enzymes are hydrolases such as proteases, amylases and lipases. Highly preferred for automatic dishwashing are amylases and/or proteases, including both current commercially available types and improved types which, though more bleach compatible, have a remaining degree of bleach deactivation susceptibility.

In general, as noted, preferred ADD compositions herein comprise one or more detersive enzymes. If only one enzyme is used, it is preferably an amyolytic enzyme when the composition is for automatic dishwashing use. Highly preferred for automatic dishwashing is a mixture of proteolytic enzymes and amyloytic enzymes. More generally, the enzymes to be incorporated include proteases, amylases, lipases, cellulases, and peroxidases, as well as mixtures thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders, etc. In this respect bacterial or fungal enzymes are preferred, such as bacterial amylases and proteases, and fungal cellulases.

Enzymes are normally incorporated in the instant detergent compositions at levels sufficient to provide a “cleaning-effective amount”. The term “cleaning-effective amount” refers to any amount capable of producing a cleaning, stain removal or soil removal effect on substrates such as fabrics, dishware and the like. Since enzymes are catalytic materials, such amounts may be very small. In practical terms for current commercial preparations, typical amounts are up to 5 mg by weight, more typically 0.01 mg to 3 mg, of active enzyme per gram of the composition. Stated otherwise, the compositions herein will typically comprise from 0.001% to 6%, preferably 0.01%-1% by weight of a commercial enzyme preparation. Protease enzymes are usually present in such commercial preparations at levels sufficient to provide from 0.005 to 0.1 Anson units (AU) of activity per gram of composition. For automatic dishwashing purposes, it may be desirable to increase the active enzyme content of the commercial preparations, in order to minimise the total amount of non-catalytically active materials delivered and thereby improve spotting/filming results.

### Enzyme Stabilizing System

The enzyme-containing compositions, especially liquid compositions, herein may comprise from 0.001% to 10%, preferably from 0.005% to 8%, most preferably from 0.01% to 6%, by weight of an enzyme stabilizing system. The enzyme stabilizing system can be any stabilizing system which is compatible with the detersive enzyme. Such stabilizing systems can comprise calcium ion, boric acid, propylene glycol, short chain carboxylic acid, boronic acid, and mixtures thereof.

The stabilizing system of the ADDs herein may further comprise from 0 to 10%, preferably from 0.01% to 6% by weight, of chlorine bleach scavengers, added to prevent chlorine bleach species present in many water supplies from attacking and inactivating the enzymes, especially under alkaline conditions.

### Optional Bleach Adjuncts

### Bleach Activators

Preferably, the peroxygen bleach component in the composition is formulated with an activator (peracid precursor). The activator is present at levels of from 0.01% to 15%, preferably from 0.5% to 10%, more preferably from 1% to 8%, by weight of the composition. Preferred activators are selected from the group consisting of tetraacetyl ethylene diamine (TAED), quaternary substituted bleach activators (QSBA), benzoylcaprolactam (BzCL), 4-nitrobenzoylcaprolactam, 3-chlorobenzoyl-caprolactam, benzoyloxybenzenesulphonate (BOBS), nonanoyloxybenzene-sulphonate (NOBS), phenyl benzoate (PhBz), decanoyloxybenzenesulphonate (C.sub.10-OBS), benzoylvalerolactam (BZVL), octanoyloxybenzenesulphonate (C₈-OBS), perhydrolyzable esters and mixtures thereof, most preferably benzoylcaprolactam and benzoylvalerolactam.

The mole ratio of peroxygen bleaching compound (as AvO) to bleach activator in the present invention generally ranges from at least 1:1, preferably from 20:1 to 1:1, more preferably from 10:1 to 3:1.

TAED and quaternary substituted ammonium bleach activators are preferred. Preferred QSBA structures are those comprising a nitril group further described in WO96/40661 A1, EP 0 303 520 A2 and EP 0 790 244 A1 incorporated herein by reference.

### Metal-Containing Bleach Catalysts

The present invention compositions and methods utilise metal-containing bleach catalysts that are effective for use in ADD compositions. Preferred are manganese and cobalt-containing bleach catalysts.

As a practical matter, and not by way of limitation, the cleaning compositions and cleaning processes herein can be adjusted to provide on the order of at least one part per hundred million of the active bleach catalyst species in the aqueous washing medium, and will preferably provide from 0.01 ppm to 25 ppm, more preferably from 0.05 ppm to 10 ppm, and most preferably from 0.1 ppm to 5 ppm, of the bleach catalyst species in the wash liquor. In order to obtain such levels in the wash liquor of an automatic dishwashing process, typical automatic dishwashing compositions herein will comprise from 0.0005% to 0.2%, more preferably from 0.004% to 0.08%, of bleach catalyst by weight of the cleaning compositions.

### pH and Buffering Variation

Many detergent compositions herein will be buffered, i.e., they are relatively resistant to pH drop in the presence of acidic soils. However, other compositions herein may have exceptionally low buffering capacity, or may be substantially unbuffered. Techniques for controlling or varying pH at recommended usage levels more generally include the use of not only buffers, but also additional alkalis, acids, pH-jump systems, dual compartment containers, etc., and are well known to those skilled in the art.

The preferred ADD compositions herein comprise a pH-adjusting component selected from water-soluble alkaline inorganic salts and water-soluble organic or inorganic builders. The pH-adjusting components are selected so that when the ADD is dissolved in water at a concentration of 1,000-10,000 ppm, the pH remains in the range of above 8, preferably from 9.5 to 11. The preferred nonphosphate pH-adjusting component of the invention is selected from the group consisting of:

1. sodium carbonate or sesquicarbonate;

2. sodium silicate, preferably hydrous sodium silicate having SiO₂:Na₂O ratio of from 1:1 to 2:1, and mixtures thereof with limited quantities of sodium metasilicate;

3. sodium citrate;

4. citric acid;

5. sodium bicarbonate;

6. sodium borate, preferably borax;

7. sodium hydroxide; and

8. mixtures of (i)-(vii).

Illustrative of highly preferred pH-adjusting component systems are binary mixtures of granular sodium citrate with anhydrous sodium carbonate, and three-component mixtures of granular sodium citrate trihydrate, citric acid monohydrate and anhydrous sodium carbonate.

The amount of the pH adjusting component in the instant ADD compositions is preferably from 1% to 50%, by weight of the composition. In a preferred embodiment, the pH-adjusting component is present in the ADD composition in an amount from 5% to 40%, preferably from 10% to 30%, by weight.

For compositions herein having a pH between about 9.5 and 11 of the initial wash solution, particularly preferred ADD embodiments comprise, by weight of ADD, from 5% to 40%, preferably from 10% to 30%, most preferably from 15% to 20%, of sodium citrate with from 5% to 30%, preferably from 7% to 25%, most preferably from 8% to 20% sodium carbonate.

The essential pH-adjusting system can be complemented (i.e. for improved sequestration in hard water) by other optional detergency builder salts selected from nonphosphate detergency builders known in the art, which include the various water-soluble, alkali metal, ammonium or substituted ammonium borates, hydroxysulfonates, polyacetates, and polycarboxylates.

### Water-Soluble Silicates

The present automatic dishwashing detergent compositions may further comprise water-soluble silicates. Water-soluble silicates herein are any silicates which are soluble to the extent that they do not adversely affect spotting/filming characteristics of the ADD composition.

Examples of silicates are sodium metasilicate and, more generally, the alkali metal silicates, particularly those having a SiO₂/Na₂O ratio in the range 1.6:1 to 3.2:1; and layered silicates, such as the layered sodium silicates described in U.S. Pat. No. 4,664,839, issued May 12, 1987 to H. P. Rieck of which the material commercialised by Clariant under the name Na SKS-6 (which is the δ-Na₂SiO₅ form of layered silicate) is preferred.

Silicates particularly useful in automatic dishwashing (ADD) applications include granular hydrous 2-ratio silicates such as BRITESIL® H20 from PQ Corp., and the commonly sourced BRITESIL® H24 though liquid grades of various silicates can be used when the ADD composition has liquid form. Within safe limits, sodium metasilicate or sodium hydroxide alone or in combination with other silicates may be used in an ADD context to boost wash pH to a desired level.

### Chelating Agents

The compositions herein may also optionally contain one or more transition-metal selective sequestrants, “chelants” or “chelating agents”, e.g., iron and/or copper and/or manganese chelating agents. Chelating agents suitable for use herein can be selected from the group consisting of aminocarboxylates, phosphonates (especially the aminophosphonates), polyfunctionally-substituted aromatic chelating agents, and mixtures thereof. Commercial chelating agents for use herein include the DEQUEST® series, and chelants from Monsanto, DuPont, and Nalco, Inc.

Aminocarboxylates useful as optional chelating agents are further illustrated by ethylenediaminetetr-acetates,N-hydroxyethyl-ethylenedi-aminetriacetates,nitrilotracetates, ethylenediamine tetraproprionates, triethylene tetraaminehexacetates, diethylenetriamine-pentaacetates, and ethanoldiglycines, alkali metal, ammonium, and substituted ammonium salts thereof. In general, chelant mixtures may be used for a combination of functions, such as multiple transition-metal control, long-term product stabilisation, and/or control of precipitated transition metal oxides and/or hydroxides.

Aminophosphonates are also suitable for use as chelating agents in the compositions of the invention when at least low levels of total phosphorus are acceptable in detergent compositions, and include the ethylenediaminetetrakis (methylenephosphonates) and the diethylenetriaaminepentakis (methylene phosphonates). Preferably, these aminophosphonates do not contain alkyl or alkenyl groups with more than 6 carbon atoms.

If utilised, chelating agents or transition-metal-selective sequestrants will preferably comprise from 0.001% to 10%, more preferably from 0.05% to 1% by weight of the compositions herein.

### Dispersant Polymers

Preferred ADD compositions herein may additionally contain a dispersant polymer. When present, a dispersant polymer in the instant ADD compositions is typically at levels in the range from 0 to 25%, preferably from 0.5% to 20%, more preferably from 1% to 8% by weight of the ADD composition. Dispersant polymers are useful for improved filming performance of the present ADD compositions, especially in higher pH embodiments, such as those in which wash pH exceeds 9.5. Particularly preferred are polymers which inhibit the deposition of calcium carbonate or magnesium silicate on dishware.

Dispersant polymers suitable for use herein are further illustrated by the film-forming polymers described in U.S. Pat. No. 4,379,080 (Murphy), issued Apr. 5, 1983.

Suitable polymers are preferably at least partially neutralized or alkali metal, ammonium or substituted ammonium (e.g., mono-, di- or triethanolammonium) salts of polycarboxylic acids. The alkali metal, especially sodium salts are most preferred. While the molecular weight of the polymer can vary over a wide range, it preferably is from 1,000 to 500,000, more preferably is from 1,000 to 250,000, and most preferably, especially if the ADD is for use in North American automatic dishwashing appliances, is from 1,000 to 5,000.

Other suitable dispersant polymers include those disclosed in U.S. Pat. No. 3,308,067 issued Mar. 7, 1967, to Diehl. Unsaturated monomeric acids that can be polymerized to form suitable dispersant polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. is suitable provided that such segments do not constitute more than 50% by weight of the dispersant polymer.

Copolymers of acrylamide and acrylate having a molecular weight of from 3,000 to 100,000, preferably from 4,000 to 20,000, and an acrylamide content of less than 50%, preferably less than 20%, by weight of the dispersant polymer can also be used. Most preferably, such dispersant polymer has a molecular weight of from 4,000 to 20,000 and an acrylamide content of from 0% to 15%, by weight of the polymer.

Particularly preferred dispersant polymers are low molecular weight modified polyacrylate copolymers. Such copolymers contain as monomer units: a) from 90% to 10%, preferably from 80% to 20% by weight acrylic acid or its salts and b) from 10% to 90%, preferably from 20% to 80% by weight of a substituted acrylic monomer or its salt and have the general formula: —[(C(R²)C(R¹)(C(O)OR³)] wherein the apparently unfilled valencies are in fact occupied by hydrogen and at least one of the substituents R¹, R², or R³, preferably R¹ or R², is a 1 to 4 carbon alkyl or hydroxyalkyl group; R¹ or R² can be a hydrogen and R³ can be a hydrogen or alkali metal salt. Most preferred is a substituted acrylic monomer wherein R¹ is methyl, R² is hydrogen, and R³ is sodium.

Suitable low molecular weight polyacrylate dispersant polymer preferably has a molecular weight of less than 15,000, preferably from 500 to 10,000, most preferably from 1,000 to 5,000. The most preferred polyacrylate copolymer for use herein has a molecular weight of 3,500 and is the fully neutralized form of the polymer comprising 70% by weight acrylic acid and 30% by weight methacrylic acid.

Other suitable modified polyacrylate copolymers include the low molecular weight copolymers of unsaturated aliphatic carboxylic acids disclosed in U.S. Pat. Nos. 4,530,766, and 5,084,535.

Agglomerated forms of the present ADD compositions may employ aqueous solutions of polymer dispersants as liquid binders for making the agglomerate (particularly when the composition consists of a mixture of sodium citrate and sodium carbonate). Especially preferred are polyacrylates with an average molecular weight of from 1,000 to 10,000, and acrylate/maleate or acrylate/fumarate copolymers with an average molecular weight of from 2,000 to 80,000 and a ratio of acrylate to maleate or fumarate segments of from 30:1 to 1:2. Examples of such copolymers based on a mixture of unsaturated mono- and dicarboxylate monomers are disclosed in European Patent Application No. 66,915, published Dec. 15, 1982.

Other dispersant polymers useful herein include the polyethylene glycols and polypropylene glycols having a molecular weight of from 950 to 30,000 which can be obtained from the Dow Chemical Company of Midland, Mich. Such compounds for example, having a melting point within the range of from 30.degree. C. to 100.degree. C., can be obtained at molecular weights of 1,450, 3,400, 4,500, 6,000, 7,400, 9,500, and 20,000. Such compounds are formed by the polymerization of ethylene glycol or propylene glycol with the requisite number of moles of ethylene or propylene oxide to provide the desired molecular weight and melting point of the respective polyethylene glycol and polypropylene glycol. The polyethylene, polypropylene and mixed glycols are referred to using the formula: HO(CH₂CH₂O)ₘ(CH₂CH(CH₃)O)ₙ (CH(CH₃)CH₂O)ₒOH wherein m, n, and o are integers satisfying the molecular weight and temperature requirements given above.

Yet other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group.

Other suitable dispersant polymers are the carboxylated polysaccharides, particularly starches, celluloses and alginates, described in U.S. Pat. No. 3,723,322, Diehl, issued Mar. 27, 1973; the dextrin esters of polycarboxylic acids disclosed in U.S. Pat. No. 3,929,107, Thompson, issued Nov. 11, 1975; the hydroxyalkyl starch ethers, starch esters, oxidized starches, dextrins and starch hydrolysates described in U.S. Pat. No. 3,803,285, Jensen, issued Apr. 9, 1974; the carboxylated starches described in U.S. Pat. No. 3,629,121, Eldib, issued Dec. 21, 1971; and the dextrin starches described in U.S. Pat. No. 4,141,841, McDonald, issued Feb. 27, 1979. Preferred cellulose-derived dispersant polymers are the carboxymethyl celluloses.

Yet another group of acceptable dispersants are the organic dispersant polymers, such as polyaspartate.

### Material Care Agents

The present ADD compositions may contain one or more material care agents which are effective as corrosion inhibitors and/or anti-tarnish aids. Such materials are preferred components of machine dishwashing compositions especially in certain European countries where the use of electroplated nickel silver and sterling silver is still comparatively common in domestic flatware, or when aluminium protection is a concern and the composition is low in silicate. Generally, such material care agents include metasilicate, silicate, bismuth salts, manganese salts, paraffin, triazoles, pyrazoles, thiols, mercaptans, aluminium fatty acid salts, and mixtures thereof.

When present, such protecting materials are preferably incorporated at low levels, e.g., from 0.01% to 5% of the ADD composition. Suitable corrosion inhibitors include paraffin oil, typically a predominantly branched aliphatic hydrocarbon having a number of carbon atoms in the range of from to 50. Additionally, the addition of low levels of bismuth nitrate (i.e. Bi(NO₃)₃) is also preferred.

Other corrosion inhibitor compounds include benzotriazole and comparable compounds; mercaptans or thiols including thionaphtol and thioanthranol; and finely divided Aluminium fatty acid salts, such as aluminium tristearate. The formulator will recognize that such materials will generally be used judiciously and in limited quantities so as to avoid any tendency to produce spots or films on glassware or to compromise the bleaching action of the compositions. For this reason, mercaptan anti-tarnishes which are quite strongly bleach-reactive and common fatty carboxylic acids which precipitate with calcium in particular are preferably avoided.

### Other Optional Adjuncts

Depening on whether a greater or lesser degree of compactness is required, filler materials can also be present in the instant ADDs. These include sucrose, sucrose esters, sodium sulfate, potassium sulfate, etc., in amounts up to 70%, preferably from 0% to 40% of the ADD composition. Preferred filler is sodium sulfate, especially in good grades having at most low levels of trace impurities.

Sodium sulfate used herein preferably has a purity sufficient to ensure it is non-reactive with bleach; it may also be treated with low levels of sequestrants, such as phosphonates or EDDS in magnesium-salt form. Note that preferences, in terms of purity sufficient to avoid decomposing bleach, applies also to pH-adjusting component ingredients, specifically including any silicates used herein.

Although optionally present in the instant compositions, the present invention encompasses embodiments which are substantially free from sodium chloride or potassium chloride.

Hydrotrope materials such as sodium benzene sulfonate, sodium toluene sulfonate, sodium cumene sulfonate, etc., can be present, e.g., for better dispersing surfactant.

Bleach-stable perfumes (stable as to odor); and bleach-stable dyes can also be added to the present compositions in appropriate amounts.

Generally preferred compositions herein do not comprise suds suppressors or comprise suds suppressors only at low levels, i.e. levels which are not able to prevent foaming when the product, devoid of the enclosing package, is added to the washing liquor of a dishwashing machine at temperatures below the cloud point of the selected surfactant.

When present suds suppressors may be, for instance, phosphate esters or silicone suds suppresing agents. Silicone suds suppressor technology and other defoaming agents useful herein are extensively documented in “Defoaming, Theory and Industrial Applications”, Ed., P. R. Garrett, Marcel Dekker, N.Y., 1973, ISBN 0-8247-8770-6, incorporated herein by reference. See especially the chapters entitled “Foam control in Detergent Products” (Ferch et al) and “Surfactant Antifoams” (Blease et al). See also U.S. Pat. Nos. 3,933,672 and 4,136,045. Highly preferred silicone suds suppressors are the compounded types known for use in laundry detergents such as heavy-duty granules, although types hitherto used only in heavy-duty liquid detergents may also be incorporated in the instant compositions. For example, polydimethylsiloxanes having trimethylsilyl or alternate end blocking units may be used as the silicone. These may be compounded with silica and/or with surface-active nonsilicon components, as illustrated by a suds suppressor comprising 12% silicone/silica, 18% stearyl alcohol and 70% starch in granular form. A suitable commercial source of the silicone active compounds is Dow Corning Corp.

If it is desired to use a phosphate ester, suitable compounds are disclosed in U.S. Pat. No. 3,314,891, issued Apr. 18, 1967, to Schmolka et al, incorporated herein by reference. Preferred alkyl phosphate esters contain from 16-20 carbon atoms. Highly preferred alkyl phosphate esters are monostearyl acid phosphate or monooleyl acid phosphate, or salts thereof, particularly alkali metal salts, or mixtures thereof.

Other common detergent ingredients consistent with the spirit and scope of the present invention are not excluded.

### Water-Soluble Polymer Material

The water-soluble enclosure for the at least one moderate to high cloud point surfactant comprises a water-soluble, preferably polymeric, material. Water-soluble polymeric materials are known in the art and comprise for instance members of the group consisting of polyvinyl alcohol (optionally partially acetalised and/or alkoxylated), polyvinyl pyrrolidone, water-soluble polyacrylates, water-soluble polyurethane, polyethyleneoxide, gelatine, cellulose derivatives and mixtures thereof. The preferred water-soluble material is polyvinyl alcohol.

Polyvinyl alcohols, (PVA) are polymers with the following structure:

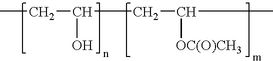

which also comprise in small amounts structural units with the following structure:

[CH₂—CH(OH)—CH(OH)—CH₂]

As the corresponding monomer, vinyl alcohol, is not to be found in free form, these polymers are obtained by hydrolysis or alcoholysis of polymers made by reaction of vinyl alcohol derivatives, preferably by transesterification of polyvinyl acetates with alcohols. Due to this manufacturing process the resulting PVA contain a residual amount of acetate groups and are designated as partially acetalised PVA.

Commercially available PVA (i.e. Mowiol®-types from Clariant) are offered as white-yellowish powders or granulates with polymerisation degrees in the range from 500 to 2500 (corresponding to molecular weights of 10.000 to 100.000 g/mol) and hydrolytic degree from 70%. They can for instance have hydrolytic degrees of from 98 to 99 mol % or from 87 to 89 mol %. They have accordingly a content in acetate groups of from 1 to 2 mol % or from 11 to 13 mol %.

The solubility of PVA can be reduced to a desired value by after-treatment with aldehydes (acetalisation), by complexation metal ions (e.g. Ni or Cu salts) or by treatment with dichromates, or crosslinking agents (e.g. boric acid, borax or titanium dioxide). Films of PVA are predominantly not permeable to gases like oxygen, nitrogen, helium, hydrogen and carbon dioxide but are permeable to water vapour.

Examples of adequate PVA films are for instance the materials offered by Syntana Handelsgesellchaft E. Harke GmbH under the tradename SOLUBLON®. Their solubility in water can be controlled to any desired degree and films can be obtained that are soluble at any desired temperature in the range which is meaningful for automatic dishwashing applications (namely between 20° C. and 70° C.).

Polyvinyl pyrrolidones (PVP) are characterised by the following formula:

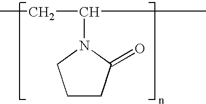

PVP are obtained by radical polymerisation of 1-vinylpyrrolidone. Commercially available PVP have molecular weights in the range from 2.500 to 75.000 g/mol and are offered as white, hygroscopic powders or as aqueous solutions.

Polyethylene oxides (abbreviated as PEOX) are polyalkylene glycols of formula:

H—(O—CH₂—CH₂)—OH

obtained normally by basic catalysed polyaddition of ethylene oxide (oxirane) to ethylene glycol. They normally have molecular weights in the range from 200 to 250.000 g/mol (corresponding to polymerisation degrees of from 5 to more than 100.000). Polyethylene oxides have only a low concentration of reactive hydroxyl groups and show therefor reduced glycol properties.

Gelatine is a polypeptide (molecular weight 15.000 to 250.000 g/mol) that is normally obtained by hydrolysis of animal skins or bones under acid or alkaline conditions. The aminoacid composition of gelatine corresponds predominantly to that of the collagen from which it derives and varies with the collagen source. The use of gelatine as water-soluble enveloping material is particularly widespread in pharmaceutical applications in the form of hard or soft gelatine capsules. In the form of films gelatine is less commonly used than the polymers mentioned before on account of its higher price.

Also preferred are cleaning products according to the invention packaged in water-soluble films made of polymers derived from starch and its derivatives, cellulose and its derivatives particularly methylcellulose and mixtures thereof.

Starch is a homoglycan in which the glucose units are connected by α-glycosidic bonds. Starch is made of two components with different molecular weights: approximately 20-30% linear chain amylose (molecular-weight 50.000 to 150.000) and 70-80% branched chain amylopectine (molecular weight 300.000 to 2.000.000). It can additionally contain low amounts of lipids, phosphoric acids and cations. While amylose consist of long fibre-type chains of 1.500 to 12.000 glucose units linked by 1,4-bounds, the chains in amylopectine are branched having linear blocks of an average 25 glucose units and building ramified molecules with and average 1.500 to 12.000 glucose units.

Besides pure starch, starch derivatives, which are obtained by polymer-analogue reactions from starch, can also be used to manufacture the water-soluble packaging of the invention. These modified starches comprise for instance products from esterification of etherification of the free hydroxyl groups in starch. It is also possible to replace the hydroxyl groups by other functional groups, which are not bound through an oxygen bond. Examples of starch derivatives are alkali starches, carboxymethyl starch, starch ester and ethers and amino starches.

Pure cellulose has the molecular formula (C₆H₁₀O₅)ₙ and is formally a cellobiose β-1,4-polyacetale, cellobiose being made of two glucose units. Adequate celluloses have from 500 to 5.000 glucose units and therefore a corresponding molecular weight of from 50.000 to 500.000. Besides pure cellulose, cellulose derivatives, which are obtained by polymer-analogue reactions from cellulose, can also be used to manufacture the water-soluble packaging of the invention. These modified cellulose comprises for instance products from esterification of etherification of the free hydroxyl groups in cellulose. It is also possible to replace the hydroxyl groups by other functional groups which are not bound through an oxygen bond. Examples of cellulose derivatives are alkali celluloses, carboxymethyl cellulose (CMC), cellulose esters and ethers and amino celluloses.

Preferred embodiments for water-soluble films according to the invention consist of polymers with a molecular weight of from 5.000 to 500.000 Dalton, preferably between 7.500 and 250.000 Dalton, particularly preferred between 10.000 and 100.000 Dalton. The water-soluble films which constitute the enclosure have preferably a thickness of 1 to 150 μm, preferably between 2 and 100 μm, particularly preferred from 5 to 75 μm, still more preferred from 10 to 50 μm.

It is also possible in a specific embodiment of the present invention to use mixtures of the above mentioned polymers as material for the water-soluble films. Additionally it is possible as well to use copolymers obtained by copolymerising mixtures of the monomers used in the manufacture of the homopolymers described above. It is for example well known to copolymerise vinylpyrolidon with vinylacetates to manufacture a copolymer whose solubility can be adjusted very precisely by adjusting the weight ratio between the two monomers.

The water-soluble films can be obtained by different manufacturing techniques. To mention a few one can cite blow moulding, calandering, casting or injection moulding.

### Method for Cleaning

The present invention also encompasses a method for cleaning soiled tableware comprising contacting said tableware with an aqueous medium comprising a moderate-to-high cloud point surfactant, as described herein before. Preferred aqueous medium have an initial pH in a wash solution of above 8, more preferably from 9.5 to 12, most preferably from 9.5 to 10.5.

This invention also encompasses a method of washing tableware in a domestic automatic dishwashing appliance, comprising treating the soiled tableware in an automatic dishwasher with an aqueous alkaline bath comprising a moderate-to-high cloud point surfactant.

The features and advantages of the present invention will become clearer upon consideration of the following specific examples, which are for illustrative purposes only and not for delimiting the invention.

### EXAMPLES

Base Formulation

| Ingredient | wt. % |
|---|---|
| Water | 37.59 |
| Na-citrate | 30.00 |
| Potassium | 30.00 |
| tripolyphosphate | |
| Polymer (Sokalan | 1.00 |
| CP5) | |
| H₂SO₄ | 0.10 |
| Polygel DA? | 0.80 |
| Protease | 0.30 |
| Amylase | 0.20 |
| Dye | 0.01 |
| Total | 100.00 |

The base formulation is used for formulating final ADWD formulations as per the following table.

| Composition | 1 | 2 | 3 | 4 |
|---|---|---|---|---|
| Base formulation | 25 g | 25 g | 25 g | 25 g |
| Plurafac LF 221 | 5 g | — | 5 g | — |
| Lutensol AT11 | — | — | — | 5 g |
| Total | 30 g | 25 g | 30 g | 30 g |

Compositions 1 and 4 are wrapped in a pouch made of polyvinyl alcohol film (C200, Nippon Gohsei) with a thickness of 120 μm, whereas compositions 2 and 3 are used as mixed without being wrapped in any packaging. Plurafac® LF 221, a surfactant brand of BASF, is an alcohol ethoxylate with a cloud point of 33° C. Lutensol® AT11, also a surfactant brand of BASF, is a alcohol ethoxylate with a cloud point of 87° C.

Composition 1 falls within the scope of the present invention and comprises a surfactant with a cloud point within the preferred range of 30° C. to 40° C., mixed together and packaged in a polyvinyl alcohol pouch. It provides good spotting results and shows little foaming.

Composition 2 on the basis of the same base formulation as composition 1, however without surfactant and unpackaged, shows little foaming, but very poor spotting results.

Composition 3, on the basis of the same base formulation and with the same surfactant as in composition 1, but unpackaged, gives good spotting results, but strongly foams from the beginning of the cleaning cycle.

Composition 4, based on the same base formulation with a surfactant having a cloud point of higher than defined for in the present invention, mixed together and packaged in a polyvinyl alcohol pouch, gives good spotting results, but strongly foams after the release of the surfactant.

Clearly, composition 1, being the only composition falling within the scope of the present claims, shows a superior combination of good spotting results and little foaming. Comparative compositions 2, 3 and 4 are either unacceptable in the spotting results or in foaming.

The features disclosed in the foregoing description and in the claims may both separately and in any combination thereof be material for realizing the invention in diverse forms thereof.

1. Cleaning product for use in automatic dishwashing comprising at least one surfactant having a cloud point in the range from 20° C. to 70° C., wherein said surfactant is enclosed in an enclosure made at least partially of a water-soluble material, the enclosure being adapted to be capable of delaying the release of its contents into the wash liquor during a cleaning cycle of the automatic dishwashing process, until when or after the temperature in the dishwashing appliance has reached the cloud point of said surfactant.

2. Cleaning product according to claim 1,
wherein the cloud point of said surfactant is below 65° C.

3. Cleaning product according to claim 1, comprising, a total surfactant content, based on a or the complete, fully functional formulation for automatic dishwashing, of between 2 and 60 wt. %.

4. Cleaning product according to claim 1, wherein the enclosure is a foil or a container.

5. Cleaning product according to claim 1, wherein the water-soluble material of the enclosure comprises a polymeric material.

6. Cleaning product according to claim 5, wherein said enclosure is essentially made of polyvinyl alcohol.

7. Cleaning product according to claim 1 comprising one or more further ingredients of an automatic dishwashing formulation.

8. Process for automatic dishwashing comprising the step of: providing a cleaning product comprising at least one surfactant having a cloud point in the range from 20° C. to 70° C. wherein said surfactant is released into the wash liquor during the cleaning cycle of the automatic dishwashing process only when or after the temperature of the wash liquor has reached the cloud point of said surfactant.

9. Process according to claim 8, wherein the cloud point of said surfactant is below 65° C.

10. Method of washing soiled tableware in an automatic dishwashing appliance comprising treating said soiled tableware with an aqueous alkaline bath comprising a cleaning product according to claim 1.

11. Cleaning product according to claim 1, wherein the cloud point of said surfactant is below 55° C.

12. Cleaning product according to claim 1, wherein the cloud point of said surfactant is below 45° C.

13. Cleaning product according to claim 1 comprising a total surfactant content, based on a or the complete, fully functional formulation for automatic dishwashing, of between 4 and 50 wt %.

14. Cleaning product according to claim 1 comprising a total surfactant content, based on a or the complete, fully functional formulation for automatic dishwashing, of between 5 and 40 wt %.

15. Cleaning product according to claim 1 comprising a total surfactant content, based on a or the complete, fully functional formulation for automatic dishwashing, of between 2 and 60 wt %.

16. Cleaning product according to claim 1 comprising a total surfactant content, based on a or the complete, fully functional formulation for automatic dishwashing, of between 4 and 50 wt %.

17. Cleaning product according to claim 1 comprising a total surfactant content, based on a or the complete, fully functional formulation for automatic dishwashing, of between 5 and 40 wt %.

18. Process according to claim 8, wherein the cloud point of said surfactant is below 55° C.

19. Process according to claim 8, wherein the cloud point of said surfactant is below 45° C.
